(19) United States
(12) Patent Application Publication
(10) Pub. No.: US 2001/0001628 A1
(43) Pub. Date: May 24, 2001

(54) THIN KEYBOARD

(76) Inventors: KAZUTOSHI WATANABE, FUKUSHIMA-KEN (JP); KAZUHIRO YOKOYAMA, FUKUSHIMA-KEN (JP); TSUYOSHI NARUSAWA, FUKUSHIMA-KEN (JP)

Correspondence Address: GUSTAVO SILLER JR, BRINKS HOFER GILSON & LIONE, P O BOX 10395, CHICAGO, IL, 60610

(21) Appl. No.: 09/350,788

(22) Filed: Jul. 9, 1999

(30) Foreign Application Priority Data
Jul. 16, 1998 (JP) 10-201627

(51) Int. Cl. B41J 5/08

(52) U.S. Cl. 400/472

(57) ABSTRACT

A keyboard comprises: a base board; and keyswitches each comprising a keytop, a support mechanism set on the base board and supporting the keytop for vertical movement, a biasing member disposed below the keytop to bias the keytop upward, and a switch element to be operated by depressing the keytop; wherein the keytop has a hard top part supported by the support mechanism, and a flexible skirt extending from the periphery of the hard top part.

### BACKGROUND OF THE INVENTION

1. Field of the Invention

The present invention relates to a keyboard to be used as an input device for entering characters and the like and, more particularly, to a thin keyboard suitable for use in combination with a notebook computer.

2. Description of the Related Art

Referring to FIG. 5 showing one of keyswitches 30 of a conventional keyboard in a side elevation, the keyswitch 30 comprises, in combination, a keytop 31, a pantograph type support mechanism 32 supporting the keytop 31, a base board 37, a pressing member 38 and a biasing member 39. The upper ends of the links of the support mechanism 32 are connected pivotally to bearing parts 33a and 33b formed in four corners of the lower surface of the keytop 31. The lower ends of the links of the support mechanism 32 are supported on bearing parts 34a and 34b formed on the base board 37. The bearing parts 33a and 34a support the corresponding ends of the links of the support mechanism 32 pivotally. The bearing parts 33b and 34b support the corresponding ends of the links of the support mechanism 32 slidably.

The pressing member 38 is formed on the lower surface of the keytop 31 opposite to the biasing member 39 disposed on the upper surface of the base board 37. The biasing member is substantially cylindrical. When the keytop 31 is depressed, the biasing member 39 pushes up the keytop 31 to return the keytop 31 to its initial position. A membrane switch sheet, not shown, is placed on the upper surface of the base board 37. When the keytop 31 is depressed, the biasing member 39 is deformed and the corresponding switch of the membrane switch sheet is closed. Thus, the keytop 31 of the keyswitch 30 disposed on the keyboard is depressed to give a signal represented by the keytop 31 to a computer.

As known from FIG. 5, the conventional keyboard has a thickness equal to the sum of the thickness A of the keytop 31, the stroke B of the keytop 31 and the thickness C of the base board 37. The values of A, B and C are at least 3 mm, 3 mm and 1 mm, respectively. Therefore, the thickness A of the keytop 31 or the stroke B of the keytop 31 must be reduced to form the keyboard 30 in a further reduced thickness. However, the reduction of the thickness of the keyboard by reducing the thickness or the stroke of the keytop 31 entails the following problems. The reduction of the thickness A of the keytop 31 will reduce the bulkiness of the keytop 31 and may possibly spoil the appearance of the keytop 31. The reduction of the stroke B of the keytop 31 will affect adversely to the operator's feeling of touch to the keytop 31.

### SUMMARY OF THE INVENTION

The present invention has been made in view of the foregoing problems and it is therefore an object of the present invention to provide a keyboard formed in a small thickness without spoiling the appearance of its keytops and without deteriorating the feeling of touch to the keytops.

According to one aspect of the present invention, a keyboard comprises a base board; and keyswitches each comprising a keytop, a support mechanism set on the base board and supporting the keytop for vertical movement, a biasing member disposed below the keytop to bias the keytop upward, and a switch element to be operated by depressing the keytop; wherein the keytop has a hard top part supported by the support mechanism, and a flexible skirt extending from the periphery of the hard top part.

When the keytop is depressed by finger, the soft skirt comes into contact with the base board and is deformed as the keytop is further depressed, so that a sufficient stroke can be secured for the keytop. Accordingly, a gap between the keytop and the base board which must be formed to secure a sufficient stroke of the keytop in the conventional keyboard is scarcely necessary in the keyboard of the present invention. Thus, the distance between a plane including the upper surfaces of the keytops and the upper surface of the base board can be reduced and hence the keyboard can be formed in a reduced thickness.

Preferably, the skirt of the keytop starts being deformed upon the depression of the keytop by a distance to close the switch element. Then, the skirt can be deformed simultaneously with the closing of the switch element. The skirt may be in contact with the base board or may be spaced a small distance apart from the base board in a state where any pressure is not applied to the keytop.

Preferably, the hard part and the skirt are joined together. For example, the top part of the keytop maybe formed of a hard material, the skirt may be formed of a flexible material such as rubber, and the top part and the skirt may be bonded together with an adhesive or the like. The top part and the skirt may be of the same color to avoid spoiling the appearance of the keytop.

The skirt may be formed of a flexible, soft material so as to cover the top part. The keytop may be formed entirely of a flexible, soft material, and hard bearing parts to be connected to a support mechanism may be attached to the lower surface of a top part of the keytop. The hard bearing parts may be bonded to the top part with an adhesive or the like. The top part of the keytop may be formed in a thickness smaller than that of the skirt. Recesses may be formed at positions for the hard bearing parts in the lower surface of the top part of the keytop to facilitate locating the hard bearing parts on the top part of the keytop.

Thus, the keyboard of the present invention does not need the gap which must be formed in the conventional keyboard to secure the stroke of the keytop and hence the thickness of the keyboard can be reduced accordingly. Since the bulkiness of the keytop is not reduced, the appearance of the keytop is not spoiled. Since a sufficient stroke of the keytop can be secured, the feeling of touch to the keytop is not spoiled.

The application of the keyboard of the present invention to a notebook computer is effective in forming the notebook computer in a reduced thickness.

### BRIEF DESCRIPTION OF THE DRAWINGS

The above and other objects, features and advantages of the present invention will become more apparent from the following description taken in connection with the accompanying drawings, in which:

FIG. 1 is a perspective view of a computer;

FIG. 2 is a side elevation of one of keyswitches included in a keyboard in a preferred embodiment according to the present invention in a nonactuated state;

FIG. 3 is a side elevation of the keyswitch shown in FIG. 2 in an actuated state;

FIG. 4 is a side elevation of one of keyswitches included in a keyboard in a second embodiment according to the present invention in a nonactuated state; and

FIG. 5 is a side elevation of one of keyswitches included in a conventional keyboard.

### DESCRIPTION OF THE PREFERRED EMBODIMENTS

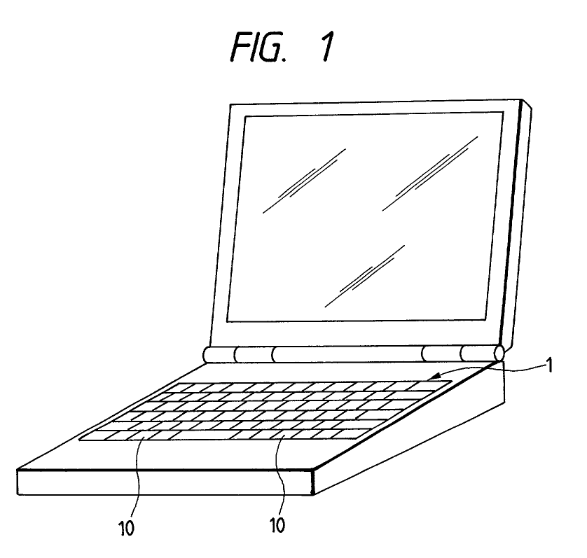

Referring to FIG. 1, a keyboard 1 in a first embodiment according to the present invention is provided with an array of a plurality of keyswitches 10. The keyboard 1 can be applied to a notebook computer.

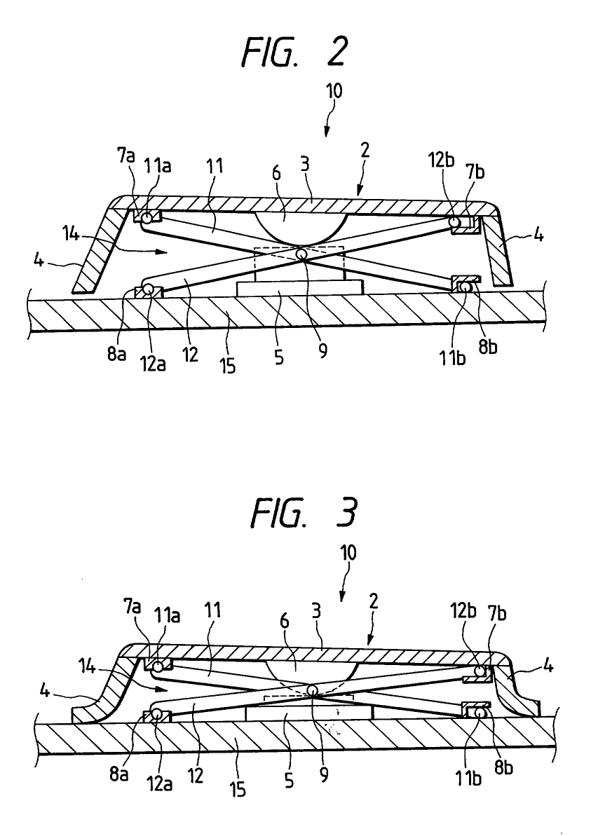

Referring to FIG. 2 showing one of the keyswitches 10 of the keyboard 1, the keyswitch 10 comprises a keytop 2, a support mechanism 14 set on a base board 15 to support the keytop 2 for vertical movement, and a biasing member 5 mounted on the base board 15. The keytop 2 has a substantially flat hard top part 3, and a skirt 4 extending from a peripheral part of the top part 3 toward the base board 15. The hard top part 3 is formed of a hard resin, such as an ABS resin. The skirt 4 is formed of rubber or an elastic resin which permits the skirt 4 to be deformed when the keytop 2 is depressed by finger. The skirt 4 is formed so that a small gap is formed between the edge of the skirt 4 and the base board 15 when the keyswitch 10 is in an nonactuated state. The skirt 4 may be formed so that its edge is in contact with the base board 15 when the keyswitch 10 is in a nonactuated state.

Bearing parts 7a and 7b are formed on the hard top part 3 in four corners of the lower surface of the hard top part 3. In FIG. 2, only the bearing parts 7a and 7b on the side out of the sheet are shown. A hemispherical pressing member 6 is formed in a central region in the lower surface of the hard top part 3. When the keytop 2 of the keyswitch 10 is depressed, the hemispherical pressing member 6 presses the biasing member 5.

The support mechanism 14 comprises a first lever 11 having the shape of a flat plate, and a second lever 12 having the shape of a flat plate joined at intermediate portions thereof by a pivot 9 in a scissors-like linkage. The first lever 11 and the second lever 12 are combined so that the first lever 11 extends inside the second lever 12. Projections 11a of a circular cross section project laterally from the opposite sides of an upper end part of the first lever 11, and the projections 11a are supported pivotally on the bearing parts 7a. Projections 12b of a circular cross section project laterally from the opposite sides of an upper end part of the second lever 12, and the projections 12b are supported slidably on the bearing parts 7b. A circular opening, not shown, is formed in a central part of the first lever 11 to permit the biasing member 5 of a substantially cylindrical shape to extend therethrough.

The base board 15 is a thin plate. Bearing parts 8a and 8b are formed on the upper surface of the base board 15 to support the lower ends of the first levers 11 and the second levers 12 thereon. Projections 11b of a circular cross section project laterally from the opposite sides of a lower end part of the first lever 11, and projections 12a of a circular cross section project laterally from the opposite sides of a lower end part of the second lever 12. The projections 11b are supported slidably on the bearing parts 8b, and the projections 12a are supported pivotally on the bearings 8a.

The substantially cylindrical biasing member 5 is disposed on the base board 15 opposite to the pressing member 6. The biasing member 5 is compressed when the keytop 2 is depressed by finger. The keytop 2 is returned to its initial position by the force of the biasing member 5 when the keytop 2 is released.

A switch element, not shown, is mounted on the base board 15 at a position corresponding to the biasing member 5. The switch element is a membrane switch. An opening is formed in the base board to enable the biasing member 5 to come into contact with the switch element. When the keytop 2 is depressed to compress the biasing member 5, the biasing member 5 closes the switch element, so that a signal representing a function assigned to the keyswitch 10 is given to the computer.

Referring to FIG. 3, when he keytop 2 is depressed, the first lever 11 and the second lever 12 are turned on the pivot 9 so that the height of the support mechanism is reduced. The projections 11a of the first lever 11 turn on the bearing parts 7a, the projections 11b of the same slide horizontally in the bearing parts 8b; the projections 12a of the second lever 12 turn on the bearing parts 8a and the projections 12b of the same slide horizontally in the bearing parts 7b.

The skirt 4 is pressed against the base board 15 and an edge part of the skirt 4 is deformed so as to be bent outward as shown in FIG. 3 by the pressure exerted by finger on the keytop 2. Consequently, the keytop 2 can be moved by a stroke corresponding to the stroke B of the keytop 31 of the conventional keyswitch 30 shown in FIG. 5 and the operator is able to feel the same touch to the keytop 2 as that felt by the operator when the operator operates the conventional keyswitch 30 when the operator operates the keyswitch 10. Since the skirt 4 yields to the pressure exerted on the keytop 2 by finger to permit the keytop 2 to be depressed by the sufficient stroke, a gap between the skirt 4 of the keytop 2 and the base board 15, which must be formed to secure a sufficient stroke of the keytop in the conventional keyboard, is scarcely necessary in the keyboard of the present invention. Since the keytop 2 can be moved by the sufficient stroke, the feeling of touch to the keytop 2 is satisfactory. The appearance of the keytop 2 is not spoiled because the thickness of the keytop 2 need not be reduced.

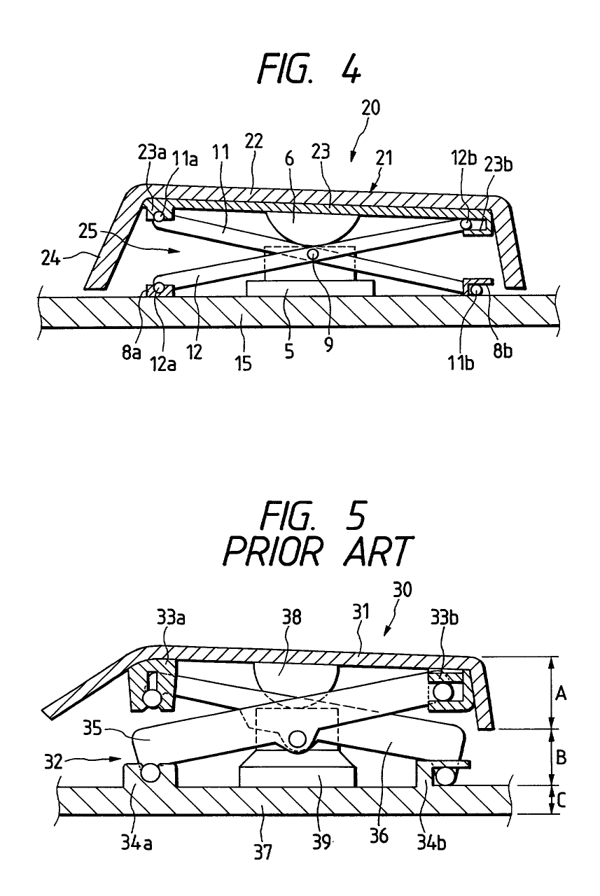

FIG. 4 shows one of keyswitches 20 included in a keyboard in a second embodiment according to the present invention. The keyswitch 20 has a keytop 21 different from that of the keyswitch 10 included in the keyboard in the first embodiment, and the keyswitch 20 shown in FIG. 4 is the same in other respects as the keyswitch 10 shown in FIGS. 2 and 3. As shown in FIG. 4, the keyswitch 20 has a keytop 21 having a top part 22 and a skirt 24 formed integrally with the top part 22. The keytop 21 is formed of a soft, flexible material. A rectangular hard member 23 is bonded to the lower surface of the top part 22 with an adhesive or the like. The hard member 23 is formed of a hard resin, such as an ABS resin. The hard member 23 is provided on its lower surface with bearing parts 23a for supporting projections 11a formed on an upper end part of a first lever 11, and a bearing members 23b for supporting projections 12b formed on an upper end part of the second lever 12.

The keyboard is formed by arranging the keyswitches 20 on the base board 15. When the keytop 21 is depressed, the skirt 24 comes into contact with the base board 15 and then the same is deformed as the keytop 21 is further depressed. An edge part of the skirt 24 is deformed so as to be bent outward as shown in FIG. 3. When the pressure applied to the keytop 21 is removed, the biasing member 5 pushes up the pressing member 6 to return the keytop 21 to its initial position.

The notebook computer including the thin keyboard in accordance with the present invention can be formed in a small thickness. The keytop 21 may be formed of a material that enables the skirt 24 to be compressed so that its length is decreased when the keytop 21 is depressed.

As apparent from the foregoing description, according to the present invention, any gap for the stroke of the keytop need not be secured between the skirt of the keytop and the base board, and the keyboard can be formed in a small thickness without spoiling the appearance of its keytops, with the sufficient stroke of the keytops secured and without deteriorating the feeling of touch to the keytops.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

What is claimed is:

1. A keyboard comprising:
a base board; and
keyswitches each comprising a keytop, a support mechanism set on the base board and supporting the keytop for vertical movement, a biasing member disposed below the keytop to bias the keytop upward, and a switch element to be operated by depressing the keytop;
wherein the keytop has a hard top part supported by the support mechanism, and a flexible skirt extending from the periphery of the hard top part.

2. The keyboard according to claim 1, wherein the skirt of the keytop is deformed upon the depression of the keytop by a distance to close the switch element.

3. The keyboard according to claim 1, wherein the hard top part and the skirt of each keyswitch are joined together.

4. The keyboard according to claim 1, wherein the skirt is formed of a flexible, soft material so as to cover the top part.
